(19) United States
(12) Patent Application Publication
(10) Pub. No.: US 2025/0045338 A1
(43) Pub. Date: Feb. 6, 2025

(54) Presenting Search And Comparison Results

(71) Applicant: Chian Chiu Li, Fremont, CA (US)

(72) Inventor: Chian Chiu Li, Fremont, CA (US)

(21) Appl. No.: 18/230,656

(22) Filed: Aug. 6, 2023

(51) Int. Cl. G06F 16/9538

(52) U.S. Cl. CPC G06F 16/9538

(57) ABSTRACT

In some aspects, systems and methods for presenting search results and comparison results are disclosed. A search window presents a search button as a search option and a comparison button as a comparison option. The search results are based on the query. The comparison results are based on an object derived from the query and comparators that are comparable to the object. In some aspects, filters are defined by users themselves. In some aspects, form filling methods are disclosed.

### CROSS REFERENCE TO RELATED APPLICATION

This is a continuation-in-part of U.S. patent application Ser. No. 17/062,641, filed Oct. 5, 2020, which is a continuation-in-part of U.S. patent application Ser. No. 15/430,465, filed Feb. 11, 2017.

### BACKGROUND-FIELD OF INVENTION

This invention relates to online search and presenting online search results, more particularly to presenting search results and comparison results after receiving a query.

### BACKGROUND-DESCRIPTION OF PRIOR ART

The Internet has become a colossal reservoir of data where we try to store almost everything which is digital. The reservoir may contain a vast amount of information covering all kinds of subjects, objects, and areas, like knowledge, data collected, records of personal and collective experiences, records of events and activities, or in some occasions, any digital info we could have. When a user wants to learn something, the user may log on a searching website to get lots of web page links, which may provide ample information on an object, such as what it is, its contact or access info, reviews, comments, and other related info posted on the Internet. A conventional search result, however, doesn't provide comparison results among competitors or similar objects directly. A conventional search may present direct introduction to an object, but not how it compares with other objects. When a user wants to see a comparison result, the user has to find online reviews first. But many objects don't have reviews. Even when reviews are available, a user has to spend time reading through them, which may not be practical in cases when immediate answer is needed such as in front of a restaurant or in a shopping mall. Thus, it's inconvenient to get comparison results using a conventional search method.

In our daily life, comparison results are important and desirable many a time. For instance, when a user is about to purchase a product, the user may want to compare it with other similar products in terms of price, reviews, and specifications. Currently, an online search is conducted around an object, not relations between an object and other objects. A user may have to do a search, rake out useful webpage links from pages of search results, get review articles, and then compare an object with another one. Thus, getting comparison results through a conventional search requires several steps and is not convenient. There exists a need for an improved search process which provides comparison results.

A database is an organized collection of data sets. It provides for storage and retrieval of data or information electronically and efficiently. There are different database types utilizing different structures to organize data sets. Take one common database structure for instance. It may contain a database table having rows and columns. Each data set may be a row, which may also be called a record or entity. An entity may contain corresponding column units of the database table, which may be called fields or attributes. For applications in conventional search and some other occasions, a regular database may consist of entities. Each entity may represent an object and contain attributes. The attributes may contain info of the object.

Usually a database features a large amount of entities. For a database used for conventional search, its entities or the entity's attributes only contain info on objects, like an object's meaning, property, and links to web pages where related info are arranged. But the entities or attributes don't include data which may be used to present comparison results among certain objects. For instance, if an object is “Pizza Time”, the attributes may involve a brief introduction of the eatery, its menu, open hours, street address, phone number, and website address. The attributes normally don't contain comparison data which is ready for retrieval for “Pizza Time” and nearby competing pizza places. To compare it with others, a user may have to do some searches, obtain relevant information, and get comparison results manually. The above comparison process requires certain knowledge, patience, and skills and thus is not a solution for all users. Therefore, there exists a need to provide an improved database which contains comparison data for direct retrieval.

### TARGETS AND ADVANTAGES

Accordingly, several main targets and advantages of the present invention are:
a). to provide an improved system and method to present online search results and comparison results;
b). to provide such a system and method which provide a search option and a comparison option simultaneously;
c). to provide such a system and method which present comparison results using concise summaries;
d). to provide such a system and method which produce a database having comparison attributes;
e). to provide such a system and method which create comparison attributes for direct retrieval of comparison data;
f). to provide such a system and method which present search results in categories;
g). to provide such a system and method which allow a user to define filters for websites and searches;
h). to provide such a system and method which provide methods to fill out forms by answering questions; and
i). to provide such a system and method which enable focused searches without input of keywords.

Further goals and advantages will become apparent from a consideration of the drawings and ensuing description.

### SUMMARY

In some embodiments, a search option and a comparison option are presented in a search window simultaneously. The search option provides conventional search results. The comparison option provides comparison results among an object and other objects. Comparison results are presented using concise summaries which feature the same format, similar or same wording, and/or a few items only. To accommodate needs of presenting comparison results, comparison attributes are created and added to a database. Comparison attributes enable quick retrieval of comparison information.

In some embodiments, search results are analyzed, grouped, and then presented in categories. In some embodiments, methods are provided for users to define filters for online information themselves. In some embodiments, users fill out forms by answering questions. In some embodiments, users perform focused searches without submitting keywords.

### DRAWING FIGURES

FIG. 1 is a block diagram showing a prior-art network environment.

FIG. 2 is a block diagram showing a prior-art server 16 of FIG. 1.

FIG. 3 is a schematic block diagram of a log processing system of a server in accordance with the present invention.

FIG. 4 is a schematic block diagram of a searching system of a server in accordance with the present invention.

FIG. 5 is a schematic flow diagram showing a process to collect info, obtain comparison data, and create attributes and an entity in accordance with the present invention.

FIG. 6 is a schematic flow diagram showing processes to retrieve and send search results and comparison results respectively in accordance with the present invention.

FIG. 7 is a schematic block diagram of a client system in accordance with the present invention.

FIGS. 8-A and 8-B are exemplary diagrams showing search and comparison options in a search interface in accordance with the present invention.

FIGS. 8-C to 8-F are exemplary diagrams showing comparison results in a search interface in accordance with the present invention.

FIG. 9 is a schematic flow diagram describing search and comparison processes respectively in accordance with the present invention.

FIGS. 10-A, 10-B, and 10-C are exemplary diagrams showing search and comparison options in a search interface in accordance with the present invention.

FIGS. 11-A and 11-B are exemplary diagrams showing categorized search results in a search interface in accordance with the present invention.

FIGS. 12-A, 12-B, 12-C, and 12-D are exemplary diagrams showing methods to set up a filter by users themselves in accordance with the present invention.

FIGS. 13-A, 13-B, 13-C, 13-D, 13-E, and 13-F are exemplary diagrams showing methods to fill out a form in accordance with the present invention.

FIGS. 14-A, 14-B, 14-C, and 14-D are exemplary diagrams showing focused search methods in accordance with the present invention.

### REFERENCE NUMERALS IN DRAWINGS

| | | | |
|---|---|---|---|
| 10 | Client | 12 | Communication Network |
| 14 | Input Module | 16 | Server |
| 18 | Output Module | 20 | Presentation Module |
| 22 | Memory & Storage | 24 | Processing Module |
| 26 | Communication Interface | 28 | Bus |
| 30 | Front End | 32 | Processing Unit |
| 34 | Site Storage | 36 | Log Data Storage |
| 38 | Search Module | 40 | Log Processing System |
| 42 | Searching System | 44 | Computer Readable Medium |
| 46 | Processor | 48 | Client |
| 50 | Display | 52 | Query Input Window |
| 54 | Search Button | 56 | Comparison Button |
| 58 | Comparison Window | 60 | Button |
| 62 | Button | 64 | Display Surface |
| 66 | Comparison Window | 68 | Display |
| 70 | Query Input Window | 72 | Display Surface |
| 74 | Search Button | 76 | Comparison Button |
| 78 | Comparison Window | 80 | Image Search Button |
| 82 | Video Search Button | 84 | Display |
| 85 | Display Surface | 86 | Region for a Category |
| 87 | Region for a Category | 88 | Region for a Category |
| 89 | Region for a Category | 90 | Region for a Category |
| 91 | Region for a Category | 92 | Display |
| 93 | Display Surface | 94 | Input Space |
| 95 | Input Space | 96 | Button |
| 97 | Button | 200 | Display |
| 201 | Display Surface | 202 | Input Space |
| 203 | Form Region | 204 | Button |
| 205 | Button | 206 | Display |
| 207 | Display Surface | 208 | Input Space |
| 209 | Button | 210 | Button |
| 211 | Button | 212 | Input region |

100, 102, 104, 106, 108, 110, 112, 114, 116, 118, 120, 122, 124, 126, 128,
130, 132, 134, 136, 138, 140, 142, 144, and 146 are exemplary steps.

### DETAILED DESCRIPTION

The following exemplary embodiments are provided for complete disclosure of the present invention and to fully inform the scope of the present invention to those skilled in the art, and the present invention is not limited to the schematic embodiments disclosed, but can be implemented in various types.

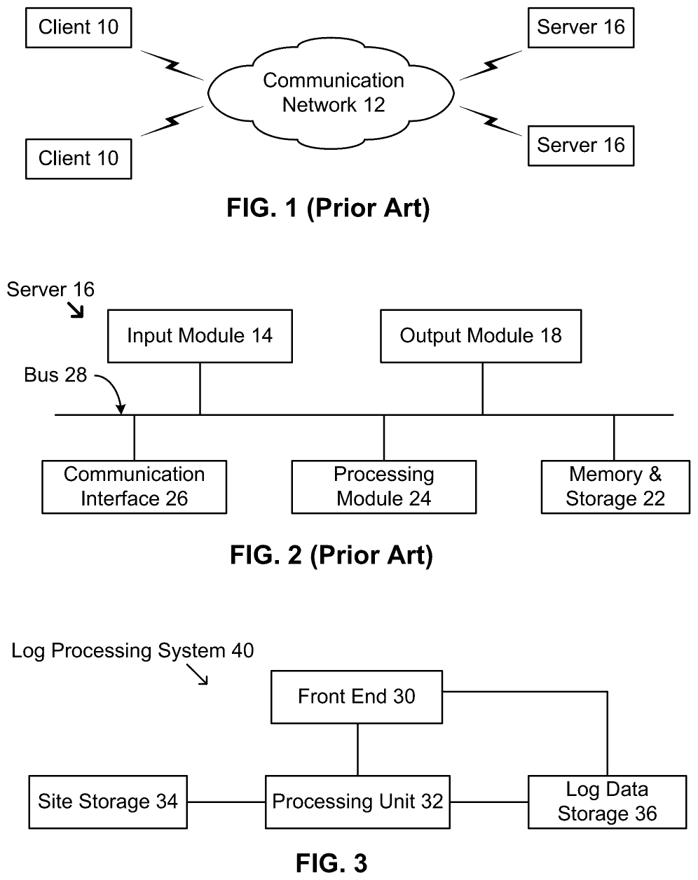

FIG. 1 is an exemplary diagram of a prior-art network system which may be used to implement principles of the current invention. The network system may comprise clients 10 and servers 16 which are connected via a communication network 12. The numbers of clients and servers in FIG. 1 are arbitrary for illustrating the methods and systems. The clients or servers may be the same or different in characteristics and their functionality may change in practical applications.

Clients 10 may cover a range of real or virtual things such as a thread or process running on a device, an object executable by a device, an electronic device or gadget, e.g., a desktop computer, a notebook computer, a tablet computer, a smartphone, a smart watch, a virtual reality (VR) device, an augmented reality (AR) device, and the like.

The word “server” as used herein means a system or systems which may have similar functions and capacities as one or more servers. Main components of a server may include one or more processors, which control and process data and information by executing software, logic, or codes, or carrying out any other suitable functions. A server and/or processor, as a computing device, may include any hardware, firmware, software, or a combination. In the most compact form, thanks to the progress of microelectronics, a server may be built on a single processor chip. In the figure, servers 16 may represent one or more server devices that collect, process, store, maintain, and/or manage information and documents, execute a search process requested by a user and deliver search results to the user.

Network 12 may cover a range of types such as a local area network (LAN), a wide area network (WAN), a telephone network, an intranet, the Internet, wireless, and other types of networks. Clients 10 and servers 16 may be connected to network 12 or among themselves by various wired, wireless, optical, direct or relayed connections.

FIG. 2 is a schematic block diagram of prior-art server 16 of FIG. 1. Server 16 may comprise an input module 14, an output module 18, a memory & storage module 22, a processing module 24, a communication interface 26, and a bus 28. Bus 28 provides communication means among the modules and devices.

Input module 14 may comprise a function that permits and enables an operator to feed information to server 16. Keyboard, mouse, voice or gesture recognition devices are examples of module 14. Output module 18 presents or displays output information. Examples of output module are monitor, printer, smart phone, or other information output devices. Memory & storage module 22 may comprises random access memory (RAM), read only memory (ROM), magnetic storage, optical storage, or other memory and storage media. Processing module 24 may comprise various types of processors which receive and execute instructions. Communication interface 26 may comprise any communication mechanism that enables server 16 to exchange information with other devices and systems either locally through bus 28 or remotely through network 12.

Processing module 24 may process information or documents obtained from web pages of various web sites, generate data associated with the web sites, and then store the data using memory & storage 22. Module 24 may also access information stored in memory & storage 22 to acquire needed data. Module 24 may perform these operations in response to executable software instructions kept in a computer-readable medium, such the RAM or ROM part of device 22.

FIG. 3 is a schematic functional block diagram of a log processing system 40 of a server according to the present invention. System 40 may comprise a front end 30, a processing unit 32, site storage 34, and log data storage 36. The blocks each may represent a processor, a thread, and/or an object. The blocks or functions depicted here and in other figures may be implemented in software, hardware, or a combination of hardware and software. Using integration or system-on-chip technologies, system 40 and other systems described here may also be built by fewer blocks or chips, or even a single block or single chip to realize functions pursued, and to reduce the system size and power consumption.

Front end 30 works as the front end of log processing system 40 and receives information or documents related to users and user access of web pages and web sites such as hypertext transfer protocol (HTTP) requests. Web access information of users includes visits on various sites and web pages, which may be sent to and stored in log data storage 36. Log storage 36, as shown in FIG. 3, is directly connected to front end 30. It stores data transferred via front end 30, which may include other user related info which is either submitted by users or collected via other means, such as user names, passwords, uniform resource locators (URLs), geographic locations, online survey records, online search records, etc.

Processing unit 32 may analyze a user by information stored in log data storage 36 and send analysis results to site storage 34. The results may illustrate user activity, history, and habit while surfing on the Internet. Main functions of site storage 34 may include collecting and storing information on almost all objects and subjects from almost all web pages. Information stored in site storage 34 may include texts, images, video, audio, documents, programs, links to web pages and website, etc.

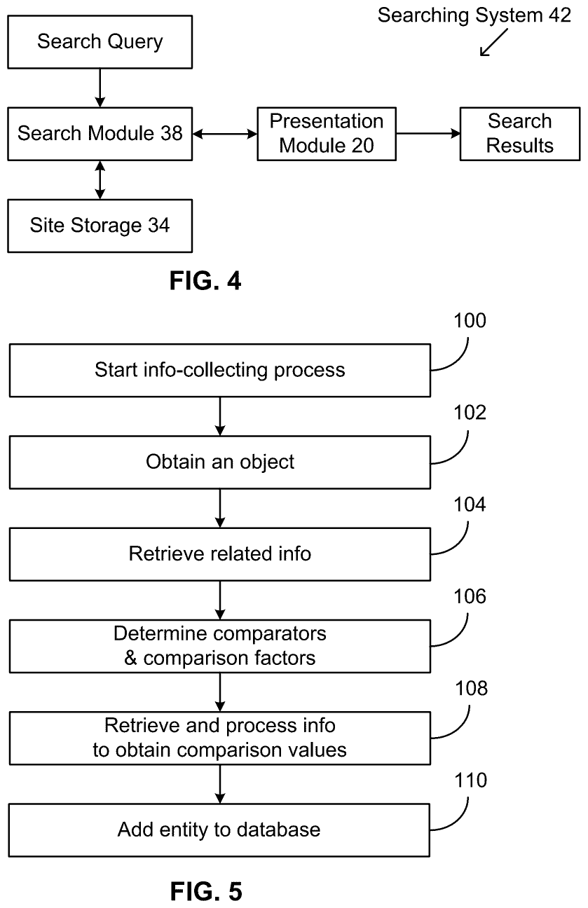

FIG. 4 is a schematic functional block diagram of a searching system 42 of a server according to the present invention. The functions illustrated in FIG. 4 may be realized by software, hardware, or a combination of hardware and software. The blocks each may represent a processor, a thread, and/or an object, and may be integrated into fewer blocks or even one block without changing the functions. A search query, as a request for information, may be any text, image, video, audio, or symbol a user submits to searching system 42. After a query is received from a user, system 42 may search the Internet accordingly, and combine the searching results with previous search results stored at site storage 34 to produce consolidated results, which may be presented to the user by text, charts, web site lists or links, etc.

Searching system 42 may comprise a search module 38 and a presentation module 20, while in practice the two modules may be integrated into one device. After search module 38 receives a search query from a user, it may analyze the query, identify a key object, access the Internet and site storage 34 to retrieve relevant documents, and then generate an initial result, which is sent to presentation module 20. Module 20 may further process the initial result, produce a search result, and then send the search result to the user. The search result may be presented in text, table, image, video, or other applicable forms. The functions of presentation module 20 may include data/information categorizing, sorting, filtering, summarizing, chart and curve drawing, and other ways to present a search result. The manner in which a search result is displayed may be determined by a user preference, an analysis on user viewing history, or a predetermined arrangement. As described above, search module 38 may have the capacity to access data and documents on the Internet and at site storage 34. After completing a search, search results and certain related info may be stored at site storage 34 for future use.

Theoretically, after receiving a search query from a user, a search may be performed via the Internet to collect up-to-date info. But searching the Internet takes time, as there are millions of websites. On the other hand, many users may want to get search results as soon as possible. Thus, a practical solution is to search the Internet, prepare search results for given groups of objects in advance, and build databases to store the search results at internal facilities like site storage 34 of FIG. 4. When a query comes in, instead of spending time searching the Internet, system 40 may locate a matching object at the databases and retrieve prearranged search results in a short period of time. As info posted on the Internet may be created, updated, or changed constantly, continued searches for new info and updates on the Internet become necessary. Once new data arrives, databases at site storage 34 may be updated in response.

As illustrated above, conventional databases consist of entities which only contain information that is directly related to an object, like web page links to introductory articles, relevant news, reviews, etc. After a query is received, an object is determined based on the query. Then a corresponding entity is identified and the entity's attributes are found. Info retrieved from the attributes is presented to a user as search results. With such database data, however, it is inconvenient and time-consuming to get comparison results, because obtaining comparison results involves comparing methods and collecting information on comparable objects. In order to get comparison info as fast as getting search results, a direct retrieval step is needed. Direct retrieval requires that a database contains relevant data which is ready for pick-up anytime. Thus, there exists a need for an improved database. The improved database may have comparison attributes. Comparison attributes may be created for an entity to store comparison data. From comparison attributes, comparison data may be retrieved instantly.

In some embodiments, an entity, representing an object, may contain one or more comparison attributes. Comparison attribute may store data for the object and one or more comparators. The word “comparator”, as used herein, may indicate an item or entity which the object is compared to. For example, when a database contains a pizza restaurant “Pizza Time” as an object, other pizza restaurants within a certain distance may be chosen as comparators. That is, a user may compare “Pizza Time” with these restaurants. After comparators are chosen, comparison factors may be selected or determined. Comparison factors may represent aspects to be compared, such as price, review results, certain characteristics, certain specifications, etc. Hence, an object and its comparators may have a specific group of comparison factors, or an object and its comparators may be compared via certain aspects respectively. In some embodiments, a value or status may be determined and assigned to an object or comparator under a comparison factor. The value or status may be referred to as a comparison value. When an object and its comparators each have a comparison value under a comparison factor, they may be compared by the comparison values under the comparison factor. Comparison values provide a short answer and easy-to-understand content and enable a concise comparison report that may be quick and easy to review.

Comparison attributes contain information on objects, comparators, comparison factors, and comparison values. After comparison attributes are arranged for an entity of an object, the object becomes ready for direct retrieval of comparison data. Take modules or devices of FIG. 4 for example. Assume that a database is built at site storage 34, where certain objects have one or more comparison attributes. The comparison attributes contain comparison information among the objects and their comparators. When a query is received from a user asking for comparison results of an object, search module 38 may launch a process to find an entity of the object and its comparison attributes. Then comparators, comparison factors, and comparison values are located at the attributes. Next, presentation module 20 may process the comparison data, generate comparison results, and send the results to the user. Examples of the comparators, comparison factors, comparison values, and comparison results are illustrated below.

FIG. 5 is a schematic flow diagram illustrating processes to collect data, arrange comparison information, and create a new entity in accordance with the present invention. At step 100, a process to collect and prepare information begins. Assume that a database is already constructed and the following steps are used to add an entity to it. The database is different from a traditional database in that it contains extra attributes, comparison attributes. As such, comparison data may be added to an entity according to certain rules and become part of attributes' content. As an entity stands for an object, when a new entity is created for the database, data of an object may be assigned to the new entity's attributes, e.g., comparison data may go to the comparison attributes. It is the comparison attributes that make the database different from a traditional database. Comparison attributes also make it convenient to retrieve comparison data for a searching system. It is noted that a comparison attribute is a complementary but not necessary part of an entity or database. An entity may or may not have valid comparison attributes. If an entity has comparison attributes, it provides ease for getting comparison results. If an entity has no comparison attribute or blank comparison attributes, the entity is still valid and useful.

At step 102, an object is obtained. The object will be added to the database in the form of entity. Further, a search is conducted at step 104 to retrieve information from the Internet and other sources with regard to the object. The search may be a conventional search. Search results may be processed and distributed among matching attributes.

Since a conventional search result doesn't include needed comparison information, steps 106 and 108 are arranged for preparing comparison attributes. It may be arranged such that these two steps are arranged automatically when a new entity is created for the database. It may also be arranged that when an entity of an object is created for the database, the object goes through a qualifying test first. The test may contain questions such as whether the object belongs to certain kinds of product or certain fields of business, whether it is located in certain geographic areas if it is in certain business, whether a certain number of comparison requests has been received for the object, and so on. If an object passes the test, these two steps may be carried out and comparison attributes may be set up for its entity. If it fails the test, these two steps may be skipped and its comparison attributes may be left empty.

At step 106, comparators are determined or chosen based on information of the object. For a comparison scenario, at least one comparator needs to be determined for the object. Comparators represent something comparable, i.e., they bear certain characteristics similar to the object so that they may be compared with each other. As illustrated above, certain nearby pizza places may be chosen as comparators for “Pizza Time”. These pizza places may resemble “Pizza Time” in terms of location and the nature of business which make them comparable to “Pizza Time”. Certain searches and analysis are needed to select comparators. Preferably, comparators may be selected by a given algorithm automatically.

Next, comparison factors are determined. A comparison factor may be what to be compared for. It is meaningless to compare an object and its comparators without supporting data, which is like to compare abstract names. An object and its comparators may be compared via factors such as certain properties, specifications, characteristics, or features. For example, price, battery life, and review rating by users may be the choices of comparison factors for smartphones. After comparison factors are defined, step 108 is performed. At this step, searches may be arranged to get information that is related to the object, the comparators, and the comparison factors and then the information may be processed to obtain or extract comparison values for the object and each comparator. A comparison value may represent a value, a condition, a degree, or status of an object or comparator under a comparison factor. A comparison value may have various forms such as a numerical number (e.g., a number 15 standing for fifteen hours of battery life), a textual expression (e.g., “Excellent” for review rating), number of stars, or another format of suitable expression. When a comparison event happens, it is the comparison values under a comparison factor that are compared for an object and its comparators.

Information of the object, comparators, comparison factors, and comparison values may be used to created comparison attributes. After comparison attributes are formed, they may be aggregated with other attributes of the entity. At step 110, the entity may be added to the database.

Assume that an object has an entity at a database. The entity may include comparison attributes. The comparison attributes may contain information of the object, comparators, comparison factors, and comparison values. When a request for comparison results of the object is received, a search module may find the entity at the database, and then check whether its comparison attributes are available. If the answer is yes, content of the comparison attributes may be retrieved, and comparison values may be obtained and used for display of comparison results. Since a simple and easy-to-read report is desirable among users, comparison values are expected to be short and clear. In some embodiments, a concise summary of an object or comparator under a comparison factor may be taken as a comparison value. For instance, assume that there is a task to get a comparison value. The object is a restaurant and the comparison factor is of price. Because there are many dishes on the menu, a summarization process is needed to reflect the overall price aspect of the restaurant. One summarization method is of averaging. Prices of selected dishes are averaged to get a medium price. The medium price may be used as a concise summary of prices. It may also be used as a comparison value under the price factor for the restaurant.

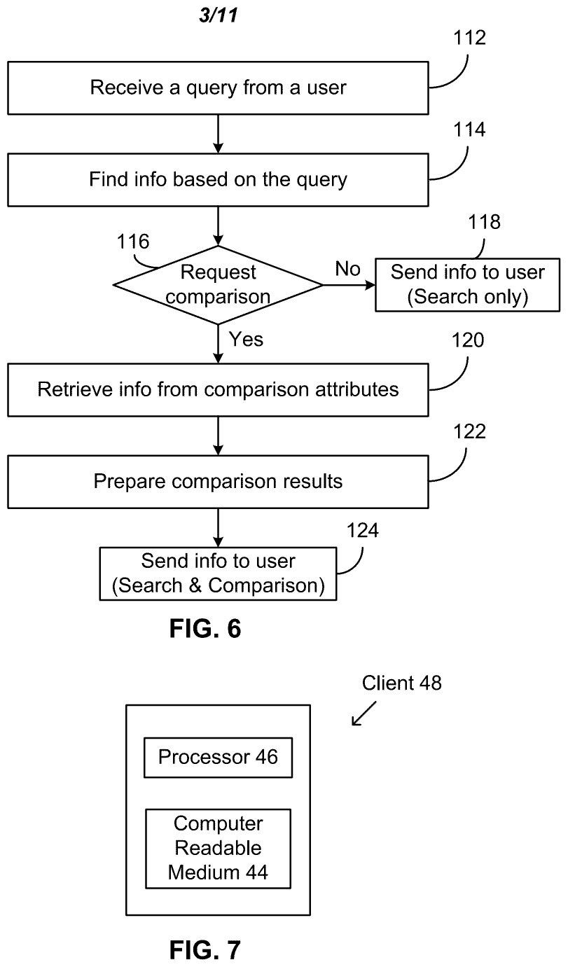

Referring to FIG. 6, assume that a server or searching system receives a query from a user at step 112. The server or searching system may start a search at given databases at step 114. Next, whether the user requests comparison results is checked at step 116. If the user asks for a conventional search, step 118 is taken and conventional search results are retrieved and sent to the user. Conventional search results contain results based on the query or around an object only. The results don't provide comparison info directly. If the user wants comparison results, Step 120 is performed. Content of comparison attributes may be retrieved by certain algorithms automatically. Optionally, not all content of comparison attributes are presented to a user at a time. Instead, data at comparison attributes is processed by the server or searching system at step 122, during which some attribute content may be selected based on the query and certain arrangements. At step 124, selected attribute content as comparison results are sent to the user.

When a user requests comparison information, conventional search results may or may not be sent to the user. As comparison results and conventional search results are complementary and both may be in need even when a user requests the former, it may be arranged that both may be given to the user as a default setting. In some embodiments, options may be arranged and presented to a user. The user may choose to receive the comparison results and skip the conventional search results. Alternatively, the users may also choose to receive both the comparison results and search results and present them on a display together.

FIG. 7 is an exemplary block diagram of a client system 48 according to the present invention. As illustrated above, client 48 may represent an electronic device, including but not limited to a desktop computer, a laptop computer, a tablet computer, a smartphone, a smart watch, a VR or AR device, etc. Client 48 may include a processor 46 and computer readable medium 44. Processor 46 may mean one or more processor chips or systems. Medium 44 may include a memory hierarchy built by one or more memory chips or storage modules like RAM, ROM, FLASH, magnetic, optical and/or thermal storage devices. Processor 46 may run programs or sets of executable instructions stored in medium 44 for performing various functions and tasks, e.g., surfing or searching on the Internet, playing video or music, electronic payment, social networking, sending and receiving emails, short messages, files, and data, executing other applications, etc. Client 48 may also include input, output, and communication components, which may be individual modules or integrated with processor 46. Communication components may connect the device to a server or another device via a communication network. Usually, client 48 may have a display (not shown) and a graphical user interface (GUI). A display may have liquid crystal display (LCD) screen, organic light emitting diode (OLED) screen (including active matrix OLED (AMOLED) screen), or LED screen. A screen surface may be sensitive to touches, i.e., sensitive to haptic and/or tactile contact with a user, especially in the case of smart phone, tablet computer, smart watch, and certain wearable devices. A touch screen may be used as a convenient tool for a user to enter input and interact with a system.

Further, client 48 may have a voice recognition component to receive a user's verbal command or audio input. In addition, client 48 may have a gesture detection mechanism to receive a user's gesture instructions. For VR and AR devices and some wearable devices, a virtual screen or a screen having a very small size may be arranged. A virtual screen may be part of a displaying system which may not have a physical screen structure. While it is impractical or inconvenient to touch a virtual screen or very small screen, verbal commands and gesture instructions may become useful for users. In descriptions below, the word “screen” or “display” may include a device that is virtual or very small. For the latter case, a screen may be smaller than a one-inch-by-one-inch square or even smaller than a fingertip. A search interface or search window may be presented via all kinds of screens or displays including a virtual screen or very small screen.

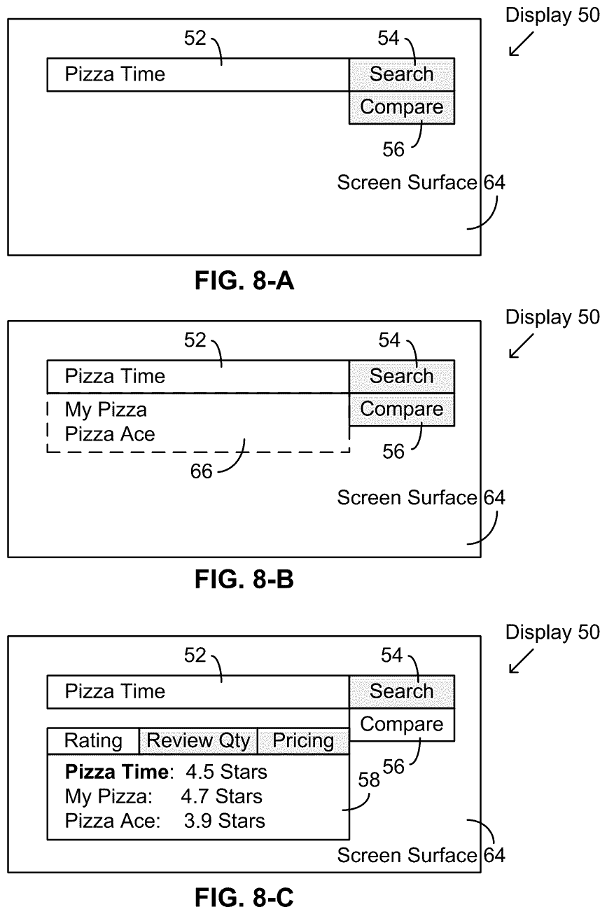

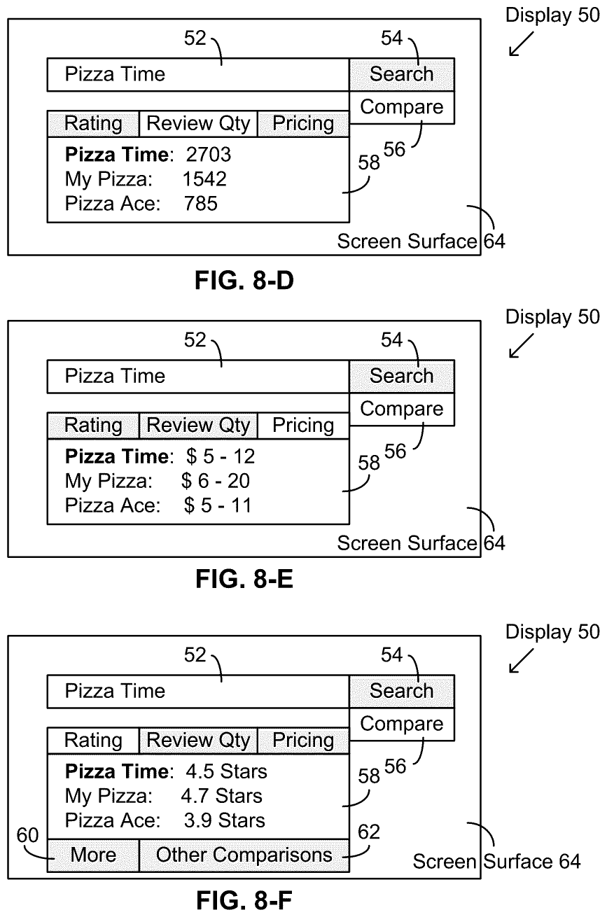

After receiving a comparison request from a user, a server or searching system may provide comparison results for presentation. FIGS. 8-A to 8-F are exemplary diagrams of presenting comparison results according to the present invention. As shown in FIG. 8-A, a search interface or search window is presented on a screen surface 64 of a display 50. Display 50 may be a part of an arbitrary client system (e.g. client system 48 as shown in FIG. 7) or electronic device. In some embodiments, the search interface may be a portal page of a search website. The content items on surface 64 may also be a portion of a screen view which mainly serves other programs, where searching functions are provided as a separate and complementary feature. For example, many websites, e.g., online stores and business reviews sites, have a searching area or search window on their web pages. In order to accommodate a search task, a query input window 52 is configured on surface 64. Window 52 represents a space for input in the interface. A user may use window 52 to enter a query in a search effort. Also arranged are interactive graphic icons or buttons 54 and 56. Button 54 serves as a search button, which may be labeled “Search” or other search symbols. A user may click on it or tap it, assuming surface 64 is touch sensitive, to start a search process or a conventional search process. In descriptions below, the verb “tap” and “click” have similar meanings and may both indicate to activate an interactive object such as an icon or button in an interface. As such, the verb “tap” and “click” may be used interchangeably in descriptions below. For a conventional search interface or search window on a screen, the search function is the only search option provided. A user may tap the search button to conduct a search, whether a search target is about an object or relations among objects.

On surface 64 however, comparison button 56 is arranged, which may be labeled “Compare” or another symbol indicating the compare meaning. In some embodiments, comparison button 56 may be placed proximate to search button 54, such as next to it, side by side, or one on top of the other. When the two buttons are next to each other, it is easy for a user to see them simultaneously and select one conveniently. Comparison button 56 may be arranged beneath button 54 as shown in the figure, on the top of button 54, or on the right hand side of it. In the latter arrangement, input window 52, buttons 54 and 56 form one line, which may be preferred in some applications. Moreover, button 56 may be arranged in an invisible state in a search interface or search window, and only become visible beside button 54 after query input window 52 receives some input. That is, comparison button 56 may be arranged in an invisible state at the beginning of a search process. Once a user starts keying in a word in window 52 or window 52 receives any input at least partially, button 56 may be switched from the invisible state to a visible state. An invisible comparison button means one fewer icon and may be helpful for arranging a neat screen view.

As shown in FIG. 8-A, a query “Pizza Time” is entered in window 52. After button 54 is tapped, a conventional search around “Pizza Time” is launched. On the other hand, when button 56 is tapped, a search for comparison results is initiated. To get comparison results, the searching system may first determine that the object is “Pizza Time” and then find out whether there is an entity at a database which represents the object “Pizza Time”. In this case, it is relatively simple to figure out a matching object from the query, as it is the query itself. If a query matches more than one object, the searching system may select one based on prearranged rules and begin a search process via the selected object. Alternatively, when a query matches multiple objects, a searching system may proceed along another route which is described below.

Return to FIG. 8-A. The screen view may remain the same after a query is keyed in, and may change after button 54 or 56 is tapped. In some other embodiments, when comparison results are available for an object, certain comparators may show up automatically right after a query is entered, which is illustrated graphically in FIG. 8-B. For example, after a user enters “Pizza Time” in window 52, a temporary comparison window 66 may show up below window 52. Comparators such as “My Pizza” and “Pizza Ace” may be presented in the temporary window 66. The two comparators may be selected from a group of comparators at comparison attributes. Window 66 may help a user in a search process, as it provides certain comparison information in advance. But appearance of a temporary comparison window doesn't mean comparison results will be retrieved and displayed. A user may still need to tap button 56 to get comparison results. In the meantime, a user may also tap button 54 for a conventional search.

In addition, after a user keys in a word or part of a word in window 52, temporary window 66 may show up and display a list of suggested queries. The suggested queries may be made based on a user's search history and possible queries containing the incomplete input in window 52. If a suggested query matches an object on record, selected comparators may appear along with suggested queries in window 66. When comparators and suggested queries are shown in window 66 together, a symbol like “Compare” may be arranged beside the comparators to distinguish them from the queries. After viewing the content items in window 66, a user may either tap a suggested query for a conventional search, or tap comparison button 56 for comparison results. Thus, window 66 may be arranged to assist two options or two kinds of searches.

After button 56 is tapped, its color and brightness may change to show the user selection and comparison results may be retrieved and presented as in FIG. 8-C. Upon receiving a query and comparison request, the searching system may find an object which matches a key item of the query. For the query “Pizza Time”, assume that there exists a matching object with the same name. Then, the object's entity and attributes are located at a database by the searching system. From the comparison attributes, comparators, comparison factors, and comparison values may be retrieved. Optionally, due to the screen size limit, not all comparators may be presented at a time. As shown in FIG. 8-C, two comparators “My Pizza” and “Pizza Ace” may be selected and presented in a comparison window 58. The two pizza competitors may be chosen based on their business nature and the close distance to “Pizza Time”. For the object and two comparators, a comparing act may be performed through comparison factors. As there may be many comparison factors, the searching system may select some for the user via certain algorithms according to prearrangements. For example, comparison factors “Rating”, “Review Qty”, and “Pricing” may be chosen and presented in window 58 as a default setting. In window 58, there may be three interactive icons that represent the comparison factors and bear their names respectively. When an icon is tapped, color of the icon may become brighter and corresponding comparison values may appear.

After window 58 appears, values of “Rating” may be shown as the first comparison results. The term “Rating” may be used to reflect how users feel about a business or product. For instance, on some reviews sites or in feedback emails, a user may be asked to rate a service or product, like using the number of stars. Summarization of the ratings, which may be done by an averaging method, may generate an average value. The average value may be used as a comparison value as well as a concise summary. In FIG. 8-C, the three businesses have 4.5, 4.7, and 3.9 stars respectively. Thus, it becomes easy and quick to compare the pizza places in terms of rating.

Next, the user may be interested in the “Review Qty” factor and may tap its icon to see the quantity of reviews each business receives in a given period of time. The comparison results are shown graphically in window 58 of FIG. 8-D. Quantity of reviews, which may be written and posted by users, may shed light on the popularity of a business or a product. More reviews may mean more customers and more popular. Thus comparison factor of review number may be a useful indicator when a user is making a decision on where to have a meal. The last comparison factor chosen by the searching system is of “Pricing”. The user may tap on its icon and get a screen view as shown in FIG. 8-E. Unlike the other two comparison factors, a value of “Pricing” factor may be a range, instead of a single number, although the average price may be used as the comparison value too. A price range may show the lowest price and the highest price. Although a list of average prices is easy for comparison, a price range may still be favored by some users and especially by restaurant owners, as it provides more information.

In descriptions above, comparison values are displayed separately for each comparison factor. Alternatively, comparison values of multiple comparison factors may be presented simultaneously in window 58 (not shown).

Therefore, it is seen that comparison results may be easy to get via a comparison button and furthermore, an object may be compared with comparators quickly and conveniently by comparison values. As a concise summary for an object or comparator may be used as a comparison value, a comparing act may be performed by comparing concise summaries. Hence, concise summaries may be specifically arranged so that they are easy and quick to view and comprehend. For instance, concise summaries may be arranged to have the same presentation format, similar or even the same wording, and/or have only a few elements only. Summary elements may include a numerical number, a word, letter, a character, a sign, or a symbol. Comparison values as shown in FIGS. 8-C to 8-E are examples of concise summaries, which have the same format, similar wording, and a few elements only.

In some embodiments, as a default configuration, only a few comparators may be selected for presentation by a searching system, like the two pizza places in descriptions above. Since some users may want to compare an object with more comparators or some comparators chosen under different rules, more choices may be arranged in a comparison window. For example in FIG. 8-F, two interactive buttons, button 60 “More” and button 62 “Other Comparisons” may added. When button 60 is tapped, more comparators may be presented so that comparisons may be held among more pizza businesses or in a wider range. For instance, certain pizza places located farther away may be included, when the comparison attributes have information about these comparators. Button 62 may represent another option that involves comparators of different kinds. For example, after button 62 is tapped, another icon may show up with a label such as “Restaurants with similar price” and additional comparators may be presented. The additional comparators may include eateries other than a pizza restaurant, e.g., a burger shop or a pancake restaurant that have a similar price range. Comparison attributes containing information of the additional comparators may be arranged in advance. When comparators are changed, comparison factors may remain the same.

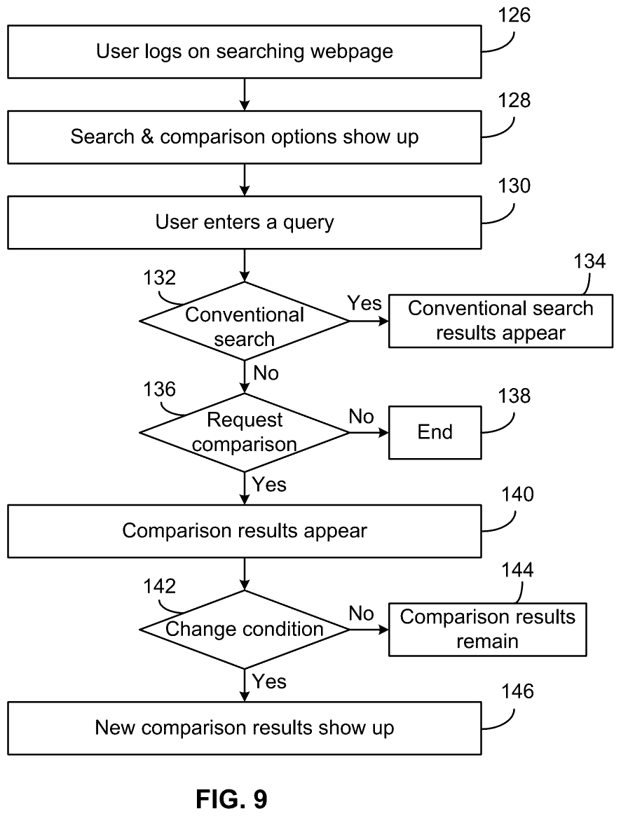

FIG. 9 shows an exemplary flow diagram that illustrates presentation of comparison results. A user logs on a search web page at an electronic device at step 126. Two options are provided on the web page for the user at step 128. The options may be represented by two interactive buttons. One option yields conventional search results, while the other option leads to comparison results. Next the user enters a query in a query input window at step 130. The user has two choices at step 132. For a conventional search, the user may activate a search button, and conventional search results may be displayed at the device at step 134. If the user doesn't want to do a conventional search, the user may tap a comparison button at step 136, and then comparison results may be obtained and presented at step 140. If the comparison button is not activated at step 140, the search process may end at step 138. At step 142 following step 140, the user needs to make another decision, i.e., whether to change the comparison condition. If the user doesn't change it, comparison results presented at the device remain the same at step 144. If the user activates a change button to change the comparison condition, such as increasing the number of comparators, showing more comparison factors, or adding additional comparators, new comparison results may be retrieved and presented at step 146.

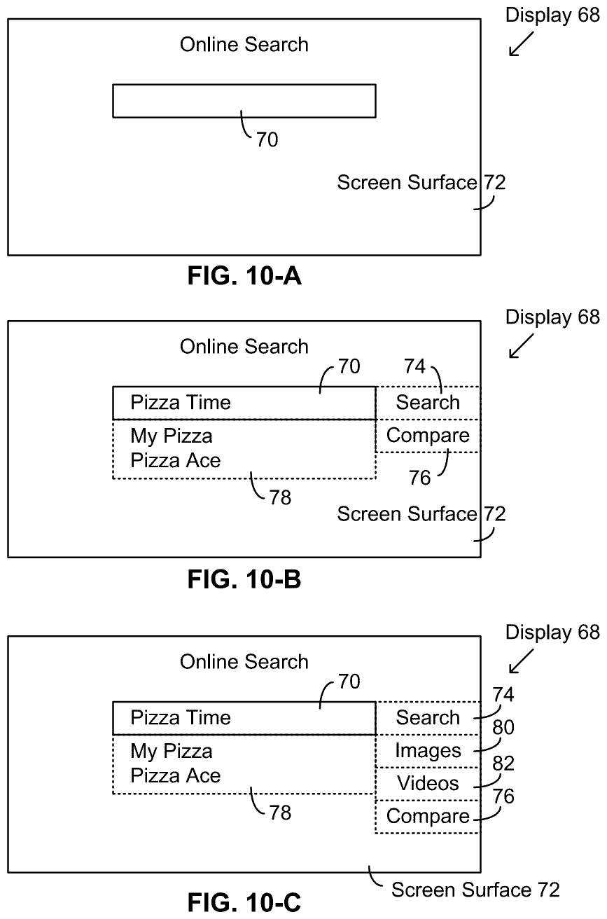

FIGS. 10-A to 10-C illustrate exemplary diagrams of presenting comparison results at a device (e.g. client system 48 as shown in FIG. 7) according to the present invention. As shown in FIG. 10-A, a search interface or search window is arranged on a screen surface 72 of a display 68 at the device. The interface includes a query input window 70. The query input window may also be referred to as a query input space. A search button and a comparison button are not displayed initially, which may make the interface clean and neat. After a user enters a query in window 70, a search button 74 and a compare button 76 may show up together, e.g., on the right-hand side of window 70, as illustrated in FIG. 10-B. In some embodiments, buttons 74 and 76 may become visible after a query is entered at least partially in window 70, such as after a letter, a sign, or a number is entered. After a query, e.g., “Pizza Time”, is received at the device, corresponding comparators may be displayed or become visible in a comparison window 78, as depicted in FIG. 10-B. In some other embodiments, some items, which are not comparators but related to “Pizza Time” in certain ways, may also be displayed as suggested queries for a search in window 78.

After the query “Pizza Time” is entered and buttons 74 and 76 are presented, the user may tap on button 74 for conventional search results, or tap on button 76 for comparison results. The query may be transmitted to a search system or service facility by the device. Conventional search results and/or comparison results may be retrieved at the search system or service facility and sent to the device for presentation.

Alternatively, after a query is entered at least partially in window 70, buttons 80 and 82 may be presented (e.g., becoming visible) along with buttons 74 and 76 in the interface on surface 72, as shown in FIG. 10-C. Button 80 may be arranged for requesting an image search, and button 82 may be arranged for requesting a video search. As images and videos are popular search items, the needs for image search and video search grow steadily. As such, convenient options for image search and video search are desirable for a search interface, especially among young people. The image search and video search are different from a conventional search in that a search is focused on images or videos related to a search query. While conventional search results include information of all type of formats (e.g., textual content, images, audio, video, etc.), image search results may mainly include information related to images such as images or links to image files, and video search results may mainly include information related to videos such as videos or links to video files.

When buttons 80 and 82 are arranged, in some embodiments, the starting page may be similar to the interface shown in FIG. 10-A, i.e., clean and neat without showing any search buttons. After a query is entered at least partially, buttons 74, 76, 80, and 82 may appear together. A user may activate one among the four search buttons to start a conventional search, a comparison search, an image search, or a video search. The search process may be similar to those illustrated above. For example, after a search button is activated, the device may detect the user action, send a search request and a query received at the device to a service facility, and wait for a response from the service facility. Based on the query, the service facility may retrieve conventional search results, comparison results, image search results, or video search results accordingly. The retrieved information may be sent to the device, which may present the information at the device. Hence, buttons 74, 76, 80, and 82 may be used to provide four search options simultaneous. A user may select one option to do a regular search, comparison search, image search, or video search quickly and conveniently.

In some other embodiments when the comparison function is not arranged, a search button (e.g., button 74) may be displayed in a starting search interface. After a query is entered at least partially in a query input window, an image search button and a video search button may be presented (e.g., becoming visible) and disposed proximate to the search button. As such, options for three types of searches may be provided in the interface. A user may activate one of the three buttons to request a conventional search, an image search, or a video search.

In some other embodiments when the comparison function is not arranged, a starting search interface may be configured similar to that of FIG. 10-A, e.g., a query input window is provided without displaying any search buttons. After a query is entered at least partially in the query input window, a conventional search button, an image search button, and a video search button may be presented (e.g., becoming visible). The three buttons may be disposed proximate to each other such as one over another along a vertical direction. As such, options for three types of searches may be provided in the interface at the same time. A user may activate one of the three buttons to request a conventional search, an image search, or a video search.

In a conventional search, search results are presented in a single list of items. Each item may represent an article (or web page) with a URL or web address. When an item is tapped, the article is retrieved and displayed. The item shows a title-like sentence that conveys a topic of the article but often does not reflect any tone, standpoint, or tendency with respect to the topic. Thus, users usually cannot obtain the tone, standpoint, or tendency of the article. For example, assume a user is a supporter of Mr. John Doe. The user wants to read articles that depict John Doe positively, but dislikes articles that are negative on or attack John Doe. Thus, there is a need to categorize search results and present search results in categories. As such, the user may easily find articles that are positive on John Doe, and avoid opening annoying articles that bash John Doe.

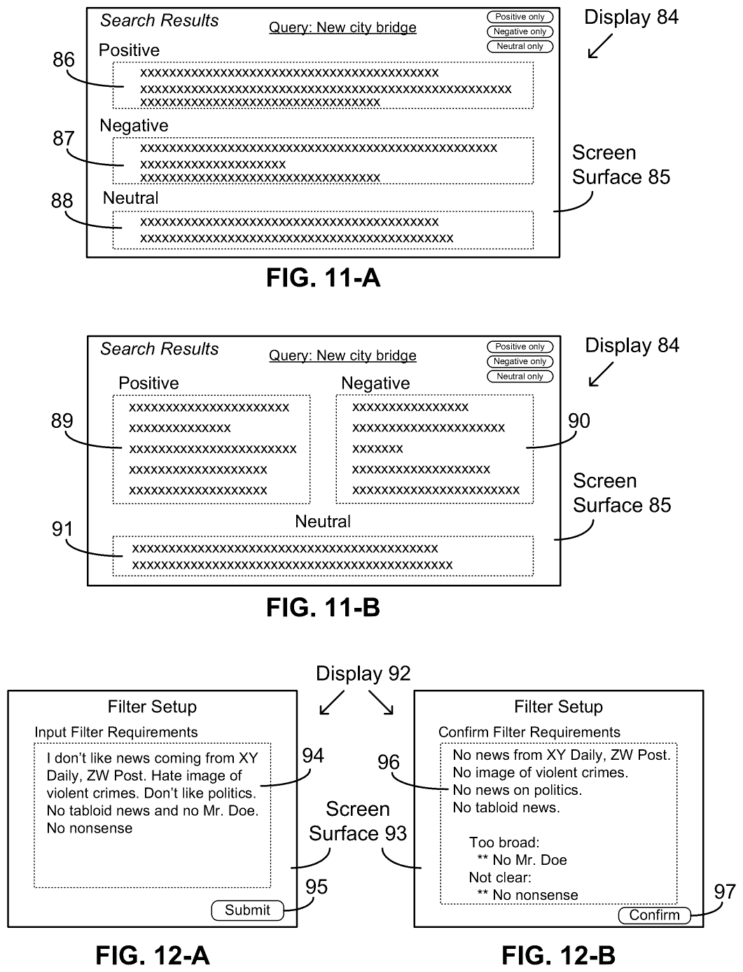

FIGS. 11-A and 11-B are exemplary diagrams of presenting search results according to the present invention. As shown in FIG. 11-A, a search interface or search window is presented on a screen surface 85 of a display 84. Display 84 may be a part of an arbitrary client system (e.g. client system 48 as shown in FIG. 7) or electronic device. In some embodiments, the search interface may be on a page created by a search website. Assume a user submits a search query “New city bridge”. Based on the query, a search system or service facility may find and retrieve search results (e.g., articles, reports, pieces of news, images, videos, etc.), categorize the search results, and divide the search results in positive, negative, and neutral categories or groups. The positive and negative groups correspond to pros and cons for building the new city bridge, respectively. The neutral group contains search results that reflect a neutral standpoint, not tilting too much to either the positive or the negative side. As such, categories containing items with opposite and neutral tones, standpoints, or tendencies are made, respectively. Categorized search results are presented in the search interface on screen surface 85. For easy access, search results with the positive, negative, and neutral tone or tendency may be arranged in regions 86, 87, and 88, respectively. The regions 86-88 are in a single-column pattern, as shown in FIG. 11-A. Optionally, regions (such as regions 89, 90, and 91) with categorized results may be configured in two columns, as shown in FIG. 11-B. Thus, the user may select an article in a group, knowing its standpoint before opening it. For some users, it may avoid frustration or anxiety as a consequence of reading irksome content.

Since there is a limited space for category regions, a scroll function may be arranged. For example, a user may scroll down the list in region 86 to read more positive articles. Optionally, three option buttons with labels “Positive only”, “Negative only”, and “Neutral only” may be arranged in the search interface, as shown in FIGS. 11-A and 11-B. For example, after the “Positive only” button is activated, only the positive category is displayed, while the other two categories are removed from the interface. That is, only articles, reports, and other items having a positive tone are presented. Optionally, the three option buttons may be replaced by a drop-down menu to save room in the interface.

After a service facility receives a query from a user, it performs a search and retrieves items (e.g., articles, reports, pieces of news, images, videos, etc.) based on the query. The query may contain one or more keywords, such as “new city bridge”. The facility may analyze the retrieved items to ascertain each item's tone, standpoint, or tendency using a software tool. As used herein, the term “software tool” may indicate algorithms, a model, or certain artificial intelligence (AI) application, program, or software. The model, e.g., a deep-learning model or large language model, may be trained with big data of various materials. Assume an item is a report. Optionally, the facility may determine a topic or subject of the report, i.e., an important aspect of the report using the software tool. The facility then detects and determines any tone, standpoint, or tendency with regard to the topic or subject through the software tool. For example, it may determine the report illustrates the topic positively, negatively, or with a neutral standpoint. The report is then sent to a corresponding category. The facility analyzes and categorizes the retrieved items, and forms three groups (e.g., positive, negative, and neutral) based on the categories as illustrated above. Each group contains items with the same or similar tone, standpoint, or tendency with regard to the determined topic or subject. The facility then sends the user the three groups of search results, facilitating presentation of the results in categories at the user's device.

Further, when an item contains multiple topics, the item may be analyzed based on one of the topics that is relevant to the query. Optionally, the facility may collect certain items posted online and categorize them in advance. As such, when the facility receives a search query from a user, it only analyzes and categorizes some newly retrieved items. As not all items need categorization work, the facility may respond fast with improved efficiency.

In some cases, the facility performs categorization and sends a user search results in categories after getting a query from the user. Optional, the facility may perform categorization and send a user search results in categories only after getting a query and a specific instruction from the user. The specific instruction may be prearranged by the facility. In some cases, a button (not shown) may be configured in the search interface and a user may tap the button to submit a query and the specific instruction. Optionally, the specific instruction may be a short command, such as “results in groups”, “split results”, “in groups”, “groups”, or “split”. A user may submit a query that includes content of the query and a short command following the content of the query to request presentation of grouped search results. For example, the query may be “new city bridge in groups”, where “in groups” is the short command that prompts the facility to divide search results into groups. Optionally, after receiving a query, the facility may detect whether there is the specific instruction which may be attached to the query or included in the query. In response to receiving the specific instruction, the facility sends search results in groups for categorized presentation. The merits of arranging the specific instruction may include better user experience and cost saving for the facility as preparing categorized items takes extra work.

Referring to FIG. 11-A, after a user opens a search app or a web page at the device, a search interface is displayed on the screen surface 85. The app or device may monitor whether the user inputs any items (e.g., words, images, or videos) as a query in a query input space (not shown). After receiving a search query, the app transmits the query to the search facility, and then receives search results from the facility. The search results may be arranged in three groups (i.e., categories) as described above. If one group has no items, this group may be omitted. The app may present the three groups in similar ways to that shown in FIG. 11-A or 11-B. That is, the search results are presented in three groups configured in three regions in the search interface. Further, adjacent to each group region, the app may present an icon or label such as “Positive”, “Negative”, or “Neutral” to clearly indicate the tone, standpoint, or tendency of items in a group. Alternatively, the groups may be labeled concisely with other words, such as “Pros”, “Cons”, and “Neutral” or icons like a thumbs-up icon, a thumbs-down icon, and a neutral icon.

In some embodiments, search results may be divided or categorized by the topic or subject of an item, instead of a standpoint with regard to a topic of the item. For example, if a query is of a popular travel destination, the search results may be categorized by topics like tourist attraction, hotel, and restaurant. Then the search results may be presented to a user in these categories with similar manners to that illustrated above. The labels for the categories may be, e.g., “Attractions”, “Hotels”, and “Eats”, respectively. Further, items in the categories may be analyzed to detect and determine their tone using the above-described methods. Exemplarily, search results may be grouped in categories with labels such as “Attractions (Pros)”, “Attractions (Cons)”, “Hotels”, and “Eats”. Items of tourist attractions with “Attractions (Pros)” and “Attractions (Cons)” labels contain positive and negative tones, respectively.

When users visit a website to read articles and news, they may not want to see certain content they dislike. For example, some users may not want to see images of violent crimes or news coming from a news agency. As such, it is desirable for a filter that blocks certain content. However, conventional methods used by websites do not provide filters configured for each user respectively, as users have different requirements, and it is impossible to satisfy every user's unique demand individually. The filter issues, however, may be resolved if users make filters according to their needs by themselves.

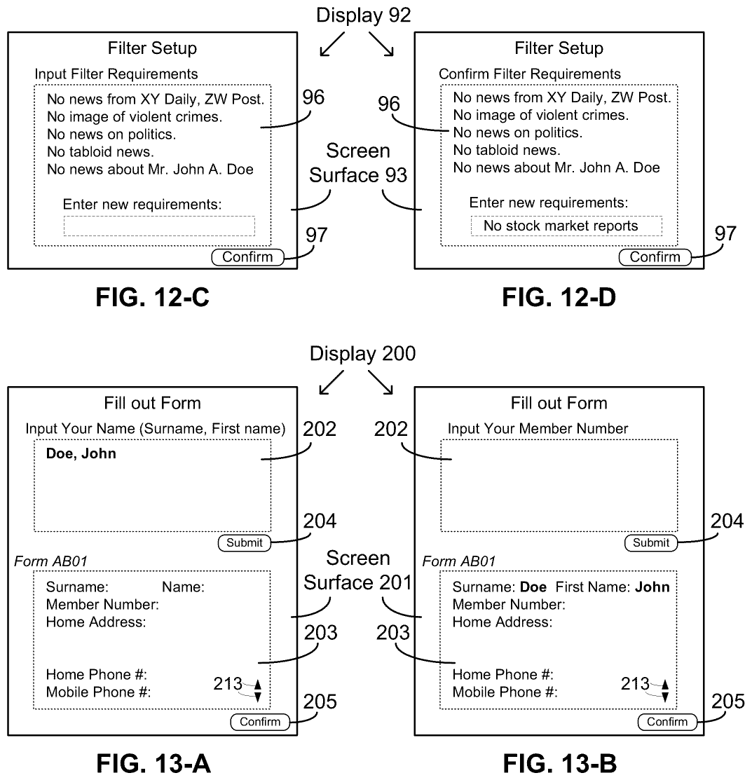

FIGS. 12-A to 12-D are exemplary diagrams of a filter setup process according to the present invention. As shown in FIG. 12-A, a filter setup interface or filter setup window is presented on a screen surface 93 of a display 92. Display 92 may be a part of an arbitrary client system (e.g. client system 48 as shown in FIG. 7) or electronic device. In some embodiments, the filter setup process may be arranged by a website. For example, after a user logs on a website, a button or drop-down menu may be arranged on a web page of the website. After the user taps the button or an item of the drop-down menu, the filter setup window may appear. The window may show a title indicating it is for setting up a filter. An input space 94 is configured in the filter setup window with an instruction “Input Filter Requirements” adjacent to and above space 94. The user may key in almost any demands for a filter in space 94. The user may also utter demands to the device, assuming a voice-recognition mechanism is enabled. The user's utterance may be received by a microphone of the device, interpreted by the voice-recognition mechanism, and then displayed in space 94.

As the filter is defined by users themselves individually, it may satisfy everyone, which is not possible if a website or organization configures it. FIG. 12-A shows requirements inputted by the user in space 94 exemplarily, such as “I don't like news coming from XY Daily, ZW Post. Hate images of violent crimes. Don't like politics. No tabloid news and no Mr. Doe. No nonsense”. The input in space 94 contains one or more sentences. As used herein, the term “sentence” may indicate a sentence that includes a subject and a verb, or a sentence that misses a subject, a verb, or both the subject and verb, or has a format of the written language or spoken language. Further, a sentence may include one or more words, icons, or emojis. A text may include one or more sentences. Each sentence in space 94 may represent a command, a statement, or an attitude, wherein the attitude may mean a feel toward a subject, a topic, a person, or an entity. In addition, the user may also input an image and video in space 94. The image and video may be represented by icons in space 94. Optionally, any image or video inputted in space 94 may mean disliked content by the user. The website may use a software tool to analyze the input in space 94 and ascertain what the user dislikes, hates, rejects, or refuses. Items (e.g., articles, news, images, and videos) with a subject (or topic) that the user dislikes, hates, rejects, or refuses should be filtered out and not presented to the user. Subject and topics may be about a tangible object (e.g., a person, a physical object, a physical product, an animal) or intangible object (e.g., an event, an image, a movie, a song, a religion, a theory). Items containing an image or video the user dislikes should also be filtered out.

The website may accept any requirement a user enters in space 94 if the requirement is doable and allowed by certain rules. Some requirements may qualify as a filter condition, while some requirements may be inappropriate and not qualified as a filter condition. After the user keys in or utters the input as shown in space 94, the user may tap a button 95 or an enter key (not shown), which prompts transmission of the requirements to the website. After analyzing the requirements through the software tool, the website sends a reply message to the user to provide feedback on the filter requirements.

As shown in FIG. 12-B, a filter confirmation space 96 with a label or instruction “Confirm Filter Requirements” is displayed in the interface, showing information received from the website. Space 96 presents a list of allowed requirements such as “No news from XY Daily, ZW Post. No image of violent crimes. No news on politics. No tabloid news.” The allowed requirements are filter conditions approved by the website, which are based the user's input, retain the same meanings as the user submitted, and may be rephrased or reworded to make it concise, easy to understand, and comply with rules made by the website. For example, a condition “No image of violent crimes” is created by the website based on the input “Hate image of violent crimes”. Thus, the website may detect and determine what the user dislikes based on requirements of the user, and configure a filter that filters out objects disliked by the user. The user may change the wording or meaning of the allowed requirements by editing them in space 96. The user may also add new filter requirements in space 96. The exemplary filter conditions in space 96 may indicate the filter blocks items (e.g., articles, news, images, and videos) published by or sent from XY Daily and ZW Post, having images of violent crimes, having subjects or topics of politics, and containing news from tabloids.

Space 96 also displays a list of rejected requirements and category names that indicate reasons for rejection. For example, “No Mr. Doe” is rejected and placed under a category name “Too broad”, as there may be too many people with the name Mr. Doe. “No nonsense” is rejected and placed below a category name “Not clear”, as the requirement is too vague. The user may change the rejected requirement by adding some words to and deleting some words from the requirement in space 96. For example, the user may change “No Mr. Doe” to “No Mr. John. A. Doe”. The revised requirement is more specific and thus has a better chance to be allowed. Then, the user taps a button 97 with, e.g., a “Confirm” label. Activation of button 97 indicates confirmation of allowed filter conditions, prompts submissions of new requirements, changes of allowed requirements, and changes of rejected requirements, and causes transmission of the confirmation and submissions to the website. If a rejected requirement is not revised by the user, the requirement may be considered abandoned. The website may accept the confirmation, review the new requirements and changes of the allowed and rejected requirements, and then send another message to the user. Space 96 then displays an updated list of allowed filter requirements for the user to confirm, as shown in FIG. 12-C. Space 96 may also display a new list of rejected requirements if it occurs.

The user may tap button 97 to confirm the updated list. If button 97 is not tapped for a certain time, the updated list may be confirmed automatically. The list may be stored at both the website and the device. The use may check the filter list by opening the filter setup window at a later time. The user may change existing requirements on the list after opening the filter setup window. Further, an input region may be configured in space 96, such as a region encircled by a dashed line below an instruction “Enter new requirements”, as shown in FIG. 12-C. The user may add new filter requirements in the input region. As illustrated in FIG. 12-D, a new filter requirement “No stock market reports” is added in the input region in space 96. The new filter requirement may be reviewed and approved by the website and confirmed by the user in similar ways to that described above.

As illustrated above, the user may log on a website, and open a filter setup window on a web page. The user may enter and submit filter requirements via the setup window. After the website (e.g., a server at the website) receives the filter requirements, the website may use the software tool to analyze meanings of the requirement, determine whether the filter requirements are acceptable based on their meanings and certain filter rules, rephrase or reword the allowed requirements when needed to make them comply with the filter rules. The website then transmits a reply message to the user. The reply message may include allowed requirements (with or without edits) and rejected requirements with reasons for rejection for presentation to the user. After the website receives a confirmation of the allowed requirements from the user, the website may use the allowed requirements as filter conditions to filter out certain items. If the website receives a confirmation along with changes of some requirements, the website may review the revised requirements in similar ways to that described above, and then send the user another reply message for confirmation. The website may repeat the processes until all allowed requirements are confirmed by the user.

Thus, a user may log on a website at a device and start a filter setup session by tapping an icon (not shown). Then, a filter setup window and an input space may be presented on a page of the website. The user may input words or sentences as one or more original filter requirements. After the user activates a submission button, the original filter requirements are transmitted to the website. Thereafter, the device may receive from the website a reply message, which may include allowed filter requirements or allowed filter requirements plus rejected requirements.

Assume all original filter requirements are allowed. A list of the allowed requirements may be presented in a confirmation window on the page. The allowed requirements may be rephrased or reworded but have the same meanings as the original filter requirements. If the user confirms the allowed filter requirements, the confirmation may be sent to the website. If the user changes any allowed requirement, the change may be sent to the website for review and approval.

Assume some original requirements are rejected by the website. The confirmation window may display two lists together, one for allowed requirements and one for rejected requirements. The allowed requirements may be edited by the website according to certain rules but keep the same meanings as the original filter requirements. The rejected requirements are displayed with a category name that indicates reasons for rejection. The user may confirm the allowed requirements and modify the rejected requirements. The confirmation and changes may be sent to the website by the device. The device then may display a new list of allowed requirements after obtaining them from the website, and transmit a confirmation message to the website after the user confirms the new list.

The above-illustrated filter configuration methods may be used for making user-defined filters. The filters may fit users' individual needs and be applied to websites that provide news, information, online shopping, etc. The above-described filter methods may also be used to configure filters for email and short message services, helping users block unwanted messages in a simple and easy way. The filter methods may also be used to set up filters for browsers to filter online and local information.

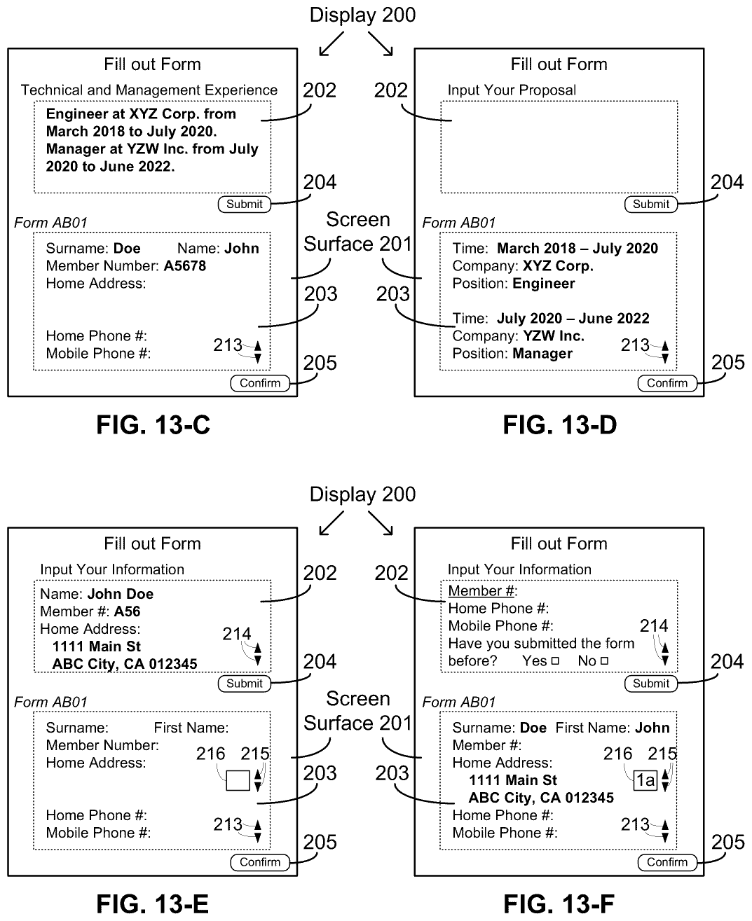

FIGS. 13-A to 13-D are exemplary diagrams for filling out forms according to the present invention. As shown in FIG. 13-A, a form filling interface or form filling window of a form filling app is presented on a screen surface 201 of a display 200. Display 200 may be a part of an arbitrary client system (e.g. client system 48 as shown in FIG. 7) or electronic device. The form filling interface includes an input space 202 and a form region 203. A user may enter needed information in input space 202. A form (e.g., Form AB01) and scroll buttons 213 are displayed in region 203. Only part of Form AB01 appears in region 203 and the user may move the form up and down to see other parts of the form using scroll buttons 213.

The app provides two options for the user to complete Form AB01. In the first option, the user may access the form in region 203 and does it the conventional way. That is, the user reads the form completely by scrolling the form in region 203, find all empty spaces that need to be filled, and fill out the empty spaces one by one. The user may tap a “Submission” button 205 to submit content directly entered in Form AB01.

In the second option, the user inputs information in space 202 to answer one or more questions/requests placed in or adjacent to space 202. For example, a request “Input Your Name” is shown above space 202 and the user enters “Doe, John” as an answer in the space in FIG. 13-A. The request “Input Your Name” may also be considered as an instruction for the user to follow, and optionally may be replace by a question like “Your name?” with the same functions and effects. The terms “request” and “question”, as used herein for the form filling methods, may indicate the same meaning and both are arranged for asking a user to input an answer for an inquiry. After the user taps a submission button 204 to submit the name, the input “Doe, John” is sent to the app. Upon receiving the input, the app analyzes “Doe, John”, recognizes the name, and then fills the form with the name information automatically, as shown in FIG. 13-B.

If this is the first input submitted in the form filling process, the act is the first submission by the user and may be considered as the first filling step (or filling step 1). Then, the second submission of input by the user may be called the second filling step (or filling step 2). The form may need many filling steps. If the filled space of Form AB01 is not shown before a filling step is performed, the app may display the just-filled part of the form in region 203 as if the app moves the form to show the just-filled part automatically. The filled part of the form may be highlighted or have a color different from that of the surrounding text. As such, the user may quickly find the just-filled part of the form in region 203 without scrolling the form, and double check it to make sure correct content is entered. After the input “Doe, John” is submitted, the app presents a new request “Input Your Member Number” above space 202, urging the user to enter another answer.

The drawbacks of the first option, i.e., the conventional method, include the difficulties to go through the form and find all empty spaces, which may be challenging or even intimidating for some users. In addition, the conventional method does not ask questions when there is an issue, and usually accepts only a fixed format for answers.

In the second option, the user may stay at and focus on one place, i.e., input space 202. The app may utilize a software tool to monitor whether the user enters any information (e.g., by keying in or uttering a word or sentence), analyzing what the user enters after receiving it via the device, and check whether information inputted by the user is correct and complies with certain rules. For a question, the user may enter one or more words or one or more sentences. For example, the user may enter “Doe, John”, “John Doe”, or “Name is John Doe” in space 202, as the software tool may analyze it and obtain the meaning of the input. Further, the app may ascertain whether the input has any issue or error. If an issue or error occurs, the app may display a question in space 202 and ask the user to correct the error or submit a new answer. Space 202 may be arranged as the main interface between the app and the user during a form filling process. Optionally, the request “Input Your Name” may be displayed inside space 202 in some cases.

In some cases, the app may present several questions in or around space 202. The user may submit answers to all questions in one step. Optionally, the user may enter answers to some questions at a time. Upon reception of the answers, the app may analyze the answers, use the answers to fill Form AB01, display a just-filled place of the form, remove answered questions from space 202, and display unanswered questions in space 202. The user then may answer the remaining questions at another time.

As shown in FIG. 13-C, the user enters two sentences for questions on technical and management experience. After the user clicks button 204 to submit the input, the app receives it through the device and analyzes the input to obtain the meaning. The app may use the software tool to do the analysis and interpretation. The app then fills some parts of the form using information obtained from the two sentences, as shown in FIG. 13-D. The figure also shows the next request, asking for a proposal. Assume the user inputs an essay (not shown) as a proposal. Then, the app may use the software tool to obtain a title, an objective, a proposed schedule, a cost estimate, etc. from the essay, and fill certain spaces of the form automatically.

Optionally, a list of questions may be displayed in space 202, as shown in FIG. 13-E. For example, questions from Form AB01 may be divided into multiple lists. Each list may be shown in space 202. If a list is long and shown partially in space 202, the list may be scrolled up and down with scroll buttons 214. Each list displays multiple questions together in an order. The user may complete the lists one by one to fill out the form. In FIG. 13-E, an exemplary list asks for information of the name, member number, and address. The user may input the information and tap button 204 to submit it. The app receives the input, analyzes it, and uses the input to fill out the form partially, as depicted in FIG. 13-F. Assume the app detects the user enters a wrong member number. Then the app may add the member number question to another list for the user to re-enter it, as illustrated in FIG. 13-F.

Optionally, the user may use both the first and second options, or switch between using the two options freely. For example, the user may enter some information in space 202 and then tap button 204 to submit it. Next, the user may scroll the form, find an empty space, fill needed information in the empty space, and then taps button 205 to submit it. That is, the user may not answer a question appearing in or next to space 202. Instead, the user may fill out some empty spaces of the form directly, and then go back to space 202 to answer the question left there.

Optionally, the user may input information in space 202 beyond the need of a question displayed there. Assume the user knows Form AB01 needs work experience information. After the form filling process begins, the app asks for name and address. In response, the user may not only input name and address, but also work experience in space 202, although the information for work experience is not asked at that stage. Optionally, the user may input in space 202 what he thinks the form may need but is not asked to provide yet, or the user may voluntarily submit an answer for a question that is not presented at a current time. The user may enter sentences or a text in space 202 as one or more answers. Further, the user may also drag an article, an image, or a video (or video clip) into space 202 (assuming the documents can be dragged from, e.g., a home page) and then tap button 204 to submit it. No matter what the user submits via space 202, a text, article, image, or video, the app may treat it as an input and do analysis using the software tool. Then, the app may use certain parts of the input to fill the form, and store other parts of the input that cannot be used for the form. The app may keep the unused parts of the input for another form that may need it. Optionally, if the app determines a space of the form needs an image inputted via space 202, the app may attach the image to that space.

Optionally, when the user enters sentences in space 202 and submit them, the app may do analysis of the sentences as described above. If the app determines the sentences are answers for certain questions not presented yet, the app may display the corresponding questions and answers in space 202 for the user to confirm. Further, the user may enter information in empty regions in space 202, whether any questions are displayed there or not. When there is a list of questions, the user may choose an empty region next to the list as an input region to enter sentences, and the input region may expand automatically in space 202 when more and more content is entered there. Information entered in the empty region of space 202 is sent to the app after the user taps button 204. Then the app may analyze the information, identify some information is answers for certain questions of the form, and use the answers to fill the form accordingly.

Optionally, as shown in FIG. 13-E, scrolling buttons 215 and a small window 216 may be configured in region 203 for the user to check every filling step during the form filling process. A number in window 216 indicates a filling step number. The user may use scroll buttons 215 to change the filling step number sequentially. In response to activation of scroll buttons 215, the app may show a new number in window 216, and a part of the form that was filled at a filling step of the new number. The user may also input a number in window 216 directly, which has the same effect as using scroll buttons 215 to get the number. For example, assume the user submits an answer “50-90%” at filling step 7. After the user enters “7” in window 216, the app may show a part of the form that is filled with “50-90%” and is filled at filling step 7. The filled part of the form at filling step 7 may be highlighted to attract attention in some cases. Thus, when the app detects the user enters a number in window 216, the app uses the number as a filling step number and displays filled content of the form at that filling step in region 203.

When the user submits multiple answers in one submission or one filling step, the multiple answers may be assigned sub-step numbers. Assume the app receives three answers at filling step 9. The app then may assign sub-steps 9a, 9b, and 9c to filling step 9. Three sub-steps correspond to the three answers, respectively. For example, FIGS. 13-E and 13-F illustrate such a case. Assume the user submits the name, member number, and address, i.e., three answers, in filling step 1. Thus, the submission includes three sub-steps. The app may assign numbers 1a, 1b, and 1c to the sub-steps. Thus, the user may check what content is entered at any filling step using scroll buttons 215 and window 216.

As illustrated above, after the user opens the form filling app at a device, the app may display input space 202, form region 203, and a request in the form filling interface or form filling window. The request may be adjacent to space 202. Optionally, the request may be placed inside space 202. The app provides two options for the user to complete the form. The user may fill out the form directly in region 203 through the first option. The user may also input answers in space 202 through the second option. The app may monitor whether the user enters any information in space 202 to answer the request, and monitor whether the user enters any information in region 203 to fill the form directly at the same time.

After the app receives information entered by the user in space 202, the app analyzes the received information to determine its content and meaning. If the input contains one or more sentences, the app may ascertain the content of each sentence and obtain information that may be used to fill the form. If the input is an answer to a question displayed, the app uses the input to fill a corresponding empty space in the form. The app then displays a part of the form where one or more empty regions are just filled with information derived from the input (or the one or more sentences). The app also displays a new question after an existing question is answered. If the input is not related to the question, the app may determine whether the input is an answer for another question of the form. If yes, the app may use the input to fill the form. In some cases, the app may display a list of questions in space 202 for the user to answer them.

Besides the app, the above-described form filling methods may also be performed by a program at a server of a website or a program at a computer of a user or organization. As such, the above-described methods may be used to fill online forms at websites or forms from agencies and organizations. The form filling method is flexible and user-friendly compared to conventional form filling methods.

A conventional online search is usually based on keywords submitted by a user. However, some users may not know what a keyword is and how to choose a word as the keyword. When they seek information of an object, they may not provide proper keywords to guide a search for the object. As the search is not well defined and focused, it may have an unnecessarily broad scope. Search results may contain too much content that is not useful. Users may go through a long list of items to find the information needed. Thus, it is desirable for a method that helps users determine keywords of a search, narrow a search, and make a search easier and more efficient.

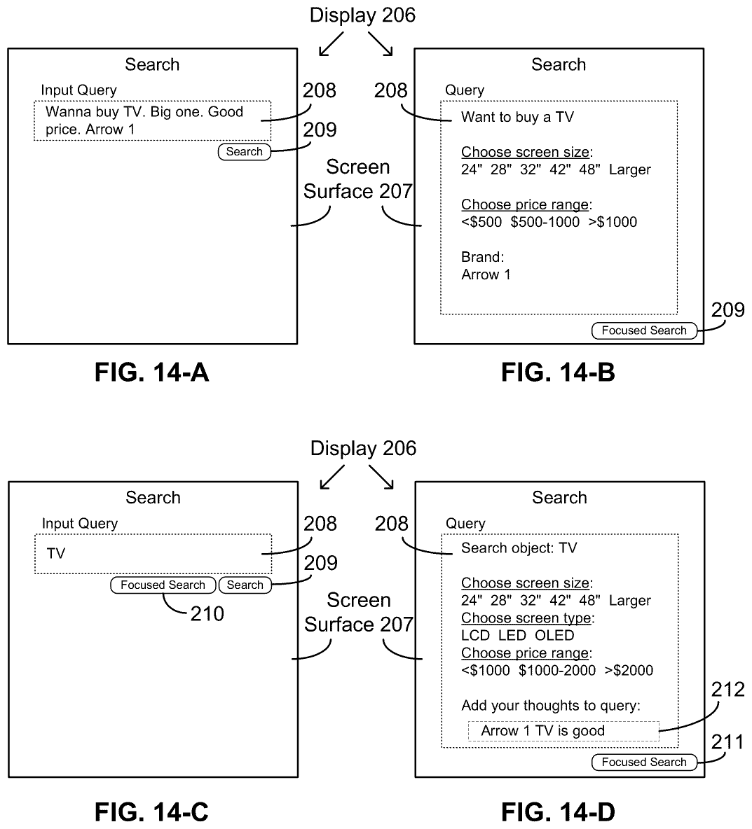

FIGS. 14-A to 14-D are exemplary diagrams illustrating online search methods according to the present invention. Assume a user opens a search app at an electronic device (e.g. client system 48 as shown in FIG. 7). The device has a display 206. As shown in FIG. 14-A, a search interface or search window of the search app is presented on a screen surface 207 of the display 206. The app may provide two search options for the user. The first option is a conventional search. In the first option, the user enters a query in an input space 208 in the search interface. The query contains one or more words as keywords. When the app detects that the query only contains keywords, the app performs a conventional search based on the keywords. The search may not be well focused and search results may have a lot of useless items.

In the second option, the user enters one or more sentences as a query in space 208. After the device detects the user taps a submission button 209 or an enter key (not shown), the device sends the query entered in space 208 to the app. The app may use a software tool to analyze the query and detect whether the query (i.e., the sentences) contains a search object, object features of the search object, intent of the search, and requirements of the search. The term “search object”, as used herein, may indicate an object that is tangible or intangible, and is a target for a search. The term “object features”, as used herein, may indicate features such as factors, parameters, properties, specifications, characteristics, user satisfaction, and/or certain opinions about the search object. The intent of a search may be referred to as the purpose of a search. For example, before a user buys a product, the user may do a search online to get information of the product. In such a case, the intent of the search is to buy the product.

Assume the user keys in a query containing exemplary sentences “Wanna buy TV. Big one. Good price. Arrow 1” in space 208 as shown in FIG. 14-A. The user may input such sentences because the sentences express the intent of the user and what the user wants to know with regard to a search object, and the user may not know how to get keywords for the search. The app may use the software tool to analyze the query and determine the following information based on the query. Search object: TV. Object features: Size, price, and brand. Intent: The user wants to buy a TV. Requirements: A big TV with a good price. Brand: Arrow 1. Optionally, an image or video inputted in space 208 may be considered as a keyword or a part of a sentence. The image or video may be represented by an icon in space 208.

As there is no definition for a big TV and good price, the app may use TV, Arrow 1 brand, big TV, screen size, and price as the keywords for a conventional search. Consequently, the search still lacks focus and search results may contain too many items that are not useful for the user.

FIG. 14-B describes an improved search method exemplarily according to the present invention. In some embodiments, in response to receiving the query as shown in space 208 in FIG. 14-A, the app may analyze the query as described above and conclude the user wants to buy a TV (i.e., search object) and mentions size, price, and brand (i.e., object features). Then, the app may display some content in space 208 in the search interface as shown in FIG. 14-B. The content presented in space 208 replaces the original query input and provides detected keywords and selectable keywords that may narrow the search range. For example, the app may display the intent of the search “Want to buy a TV”. Since the user mentions the TV brand “Arrow 1”, the brand name appears as a keyword in space 208. As the user expresses interest in size and price, the app may display, e.g., interactive objects forming a group of screen sizes and a group of price ranges. The app displays instructions (e.g., “Choose screen size” as in FIG. 14-B) to ask the user to choose a screen size and a price range. The chosen screen size and price range are object features as new keywords. Following the instructions, the user may make selections by tapping on a screen size and a price range. Assume the user taps 32″ and $500-1000.

Further, an input region (not shown) may be configured in space 208 with instructions such as “Add your words to query” (not shown), and the user may enter additional query words and sentences (e.g., “I like LED TV”) in the input region. In addition, the user may make changes of certain content in space 208. For example, the user may change the brand name from Arrow 1 to Arrow 2. After the user taps a submission button 209, the confirmed, changed, and newly added content is submitted and sent to the app. The app may monitor whether the use enters anything or changes any words or sentences in space 208, and update the query according to the new input and changes. In some cases, the app may ask the user to confirm an updated query after receiving any change or new input. Optionally, the app may skip the confirmation step and perform a search using changes the user made. In the above exemplary case, the app may use LED TV, Arrow 2 brand, screen size 32″, and price range $500-1000 as the keywords for a search. As such, the user may have a focused and efficient search by inputting sentences and then following instructions. That is, the user may do a focused search without worrying about keywords. In the above-described search process, the search object and object features are obtained from the input of the user, are used to narrow the search. The search is not based on words the user enters. Such a search is more focused on a search object than a conventional search and may be referred to as a focused search.

With reference to FIGS. 14-A and 14-B, in some embodiments, when the app detects a query only contains keywords, the app may perform a conventional search based on the keywords. When the app detects a query contains sentences and a search object and certain object features may be derived from the sentences, the app may perform a focused search as illustrated above.

In some embodiments, the app may present a button 210 adjacent to and beside button 209 in the search interface, as shown in FIG. 14-C. Assume a user enters a query in space 208. The query contains one or more sentences and a search object and object features may be obtained from the query. Then, two scenarios may be arranged by the app. In the first scenario, upon activation of either button 209 or button 210, the app starts a focused search with methods similar to that described above. In the second scenario, two options are provided. Upon activation of button 209, the app performs a conventional search based on the query; and upon activation of button 210, the app performs a focused search based on the query.

Further, when the user enters one or more keywords in space 208, the app provides two options: Upon activation of button 209, the app performs a conventional search; and upon activation of button 210, the app performs a focused search. Thus, the user may tap button 209 for a conventional search or tap button 210 to do a focused search. The terms “words” and “keywords”, as used herein, may indicate multiple words that appear together in a space but do not form any sentence.

Assume the user inputs a word “TV” in space 208, as shown in FIG. 14-C. The word “TV” may be considered as a keyword. The app may do a conventional search based on the keyword in response to activation of button 209. The app may start a focused search in response to activation of button 210. When button 210 is tapped, the app may display content in space 208 as shown in FIG. 14-D. The content in space 208 may help the app confirm a search object, identify object features that the user may care about, and thus make the search more focused. As the user only enters “TV”, the app may determine the search object is TV. The user may change the search object by removing TV and keying in another word at the same place in space 208. The app may also display, e.g., interactive objects forming a group of screen sizes, a group of screen types, and a group of price ranges as selectable object features (to be used as keywords). The app displays instructions (e.g., “Choose price range” as in FIG. 14-D), which ask the user to choose a screen size, screen type, and a price range. The user may choose not to select an object feature. Assume the user follows the instructions, and makes selections by tapping 32″, OLED, and $1000-2000. Further, an input region 212 may be configured in space 208 for the user to input any requests and thoughts. An instruction “Add your thoughts to query” is displayed above region 212. Assume the user enters a sentence such as “Arrow 1 TV is good”, indicating the user likes TVs of Arrow 1 brand and Arrow 1 brand may be used as a keyword. Then, the user may tap a submission button 211 to start the focused search. The search may be based on keywords TV, Arrow 1 brand, screen size 32″, screen type OLED, and price range $1000-2000. Compared to the conventional search with the single keyword TV, the focused search may yield search results that are more satisfactory for the user.

Referring to FIG. 14-D, as the user may make changes in space 208, the app monitors whether the use enters anything or changes any words or sentences in space 208. After the user changes some content in space 208 and enters some words or sentences in region 212, the user may tap button 211 to submit the content. In response, the app may analyze the submitted content through the software tool, determine its meaning, and then update the query content in space 208 for the user to review and confirm. If the user taps button 211 again, the app may start a focused search based on the updated query. Optionally, the app may skip the confirmation step and perform the search after the user changes certain content in space 208.

In some cases, after a search is started, the app may shrink space 208 to make room for presenting search results. If the user wants to adjust the query after search results are retrieved and displayed, the user may tap space 208. In response to a tap in space 208, the app may enlarge space 208 and show content of the query. Then the user may modify the query with similar methods to that described above and then start a new search.

Besides the app, the above-described search methods may also be performed by a program at a server of a website or a program at a device (e.g., a smartphone or computer) of a user or organization. The methods may be performed to search information on the internet or at a local storage. As such, a user may use the above-described methods to conduct searches without worrying about keywords in a variety of applications.

As illustrated above with regard to FIGS. 14-A and 14-B, the app provides two search options for a user. The app receives a query entered by the user. The app analyzes the query using the software tool. If the app detects the query contains one or more words, that app uses the first option and performs a conventional search using the one or more words as keywords. If the app detects the query contains one or more sentences, the app uses the query to determine a search object, object features, and possibly the intent and requirements of the search. Then the app employs the second option, and displays the determined search object and object features in a query space (or query window) in the search interface. The app may also display estimated intent of the search and certain selectable object features for the user to select in the query space. The app monitors whether the user adjusts the query by changing any item or adding any words or sentences in the query space. After the app detects the user submits the content with a modified query via the query space, the app analyzes the changed and added parts of the content and update the query. The app performs a focused search after the user confirms the updated query.

As illustrated above with regard to FIGS. 14-C and 14-D, the app presents another method that provides two search options. A first and second interactive buttons are configured in a search interface. Activation of the first button prompts a conventional search. Activation of the second button prompts a focused search. After a user inputs a query and taps the second button for a focused search, the app analyzes the query using the software tool. The query may contain one or more words or one or more sentences. In a conventional search, the app may use the words inputted or words selected from the sentences as keywords. As the second option is selected, the app analyzes the query to determine a search object, object features, and possibly the intent and requirements of the search. The app displays the calculated or estimated search object and object features in a query space (or query window) in the search interface. The app may also display estimated intent of the search and certain selectable object features for the user to select in the query space. The app monitors whether the user changes any item or add any words or sentences in the query space. After the app detects the user submits the content in the query space, the app analyzes the changes and added parts of the content and updates the query. The app performs a focused search after the user confirms the updated query.

### CONCLUSION, RAMIFICATIONS, AND SCOPE

Thus it can be seen that apparatus and methods are introduced to improve search methods, comparison methods, databases, filter configuration methods, and form filling methods.

The described embodiments have the following features and advantages:
(1). Search and comparison options are provided in a search window;
(2). The comparison option provides comparison results, while the search option provides conventional search results;
(3). Comparison results are presented using concise summaries;
(4). Database is improved by addition of comparison attributes;
(5). Comparison attributes contain comparison data; and
(6). Comparison attributes enable retrieval of comparison information directly;
(7). Search results are presented in categories;
(8). Online filters are defined by users according to their individual needs;
(9). Forms are filled out by answering questions; and
(10). Focused searches are conducted without input of keywords.

Although the description above contains many specificities, these should not be construed as limiting the scope of the invention but as merely providing illustrations of some of the presently preferred embodiments. Numerous modifications will be obvious to those skilled in the art.

### RAMIFICATIONS

The interface on screen surface 64 of FIGS. 8-C to 8-F may show more content items than what is depicted. As search results and comparison results are complementary, they may be obtained and presented together, when a user requests a comparison search for comparison results. For example, conventional search results may be retrieved and presented in an area below window 58. When a user looks at comparison results about an object and becomes interested in the object, the user may tap a link displayed below window 58 to learn more about it conveniently.

A comparison button like a “Compare” button may be placed close to a search button no matter what interface the search button is arranged in. That is, the comparison functionality may be arranged to take effect in any interface where the search functionality exists. The interface may be a web page of a search website, an online store website, a business reviews website, a government website, etc.

Rules may be made for selecting comparators for an object. To qualify as a comparator, it must have the same or similar features or characteristics, when compared to the object. Some features or characteristics are what a comparison is based on and may be used as comparison factors. For example, if an object is a product, other products which have similar specifications but different brands may be taken as comparators. They may be compared by price, common parameters, or other comparison factors. Besides, other products of the same brand and similar functions may be used as comparators too. If an object is a book, other books which have the same or similar topic may be enlisted as comparators. The books may be compared by review rating, price, number sold, etc. In addition, other books written by the same author but with different topics may also serve as comparators. If an object is a restaurant, nearby restaurants of the same cuisine may be chosen as comparators. Moreover, nearby restaurants which serve different cuisine with a similar price range may serve as comparators too. If an object is a country, neighboring counties or countries which the media often cite when reporting the country may be selected as comparators.

Rules may also be made for selecting comparison factors. An object and its comparators are compared by comparison values under a group of comparison factors. As comparisons may be made via various aspects, there may be many potential comparison factors. Thus, rules should be made to define which comparison factors are selected. The rules may be related to users' needs and general trend. In addition, similar objects may have the same requirements for comparison factors. For a product, possible comparison factors may include price, review rating, life time, key specifications, etc. For a book, possible comparison factors may include price, review rating, quantity sold, etc. For a country, likable comparison factors may be population, area, gross domestic product (GDP), and so on.

Besides clicking and tapping using a computer mouse or fingertip, vocal instructions may also be used to do a search and get search or comparison results, when a client system has a voice recognition mechanism or is equipped with a voice recognition component. Vocal input may be especially favored when VR and AR devices are involved, since input by tapping on a screen surface becomes unavailable. For instance, after a search interface such as that of FIG. 8-A shows up on a virtual screen, a user may speak to a VR device, “Key in “Pizza Time” please” and then utter “Compare” to start a compare process and get comparison results, e.g., comparison values under the comparison factor “Rating”. Next the user may utter “Pricing” to change the comparison factor from “Rating” to “Pricing”. In addition, when a VR device has a gesture sensor, a user may use virtual clicking or virtual tapping acts to enter input. Then the user may ask for comparison results via gesture instructions.

Sometimes when the purpose of search is to get certain images or videos, it may be arranged such that search results are presented using images or links to web pages containing videos. For such a searching process, a comparison button may still be arranged next to a search button to provide a comparison option. It may be arranged such that besides textual content, an image or video alone may represent a comparison value or concise summary as well. In other words, a comparison value or concise summary may contain an image or a video only. For instance in a comparison window like that of FIG. 8-C, images or links to video websites for an object and its comparators may be displayed under a comparison factor. A video clip may also be embedded in an icon in a search window. The icon may stand for a comparison value. A user may tap the icon to view the video directly. Thus aside from comparing things by textual content, a comparison may be made by comparing images or videos too.

In some embodiments as described above, comparison results may be presented using a few numbers, a few signs, and/or a few words in a search window. But a user may want to see comparison results in images or videos in some occasions, even though a search is not conducted among images or videos. For instance, when a user is looking at comparison results made up of numbers and words, the user may want to compare the parties by images or videos. Then, additional comparison factors may be created at comparison attributes and named, for example, “Image” and “Video”. Accordingly, additional comparison factor icons, such as “Image” and “Video”, may be arranged along with other comparison factor icons in a comparison window. As such, some comparison values may be arranged to be a selected image or video clip that represents an object. For example, a representative image of a restaurant may be a picture of its popular dish or an award-winning interior design. For a movie, a representative video may be its trailer. When “Image” or “Video” factor is selected, images or videos chosen for an object and its comparators may be displayed together, which make it convenient for a user to compare one against another. Comparison of images or videos may be useful when a user tries to choose a movie, a TV show, a concert, a restaurant, a park, and so on.

When a query or object has multiple meanings, multiple temporary comparison windows like window 66 of FIG. 8-B may appear in a search interface. The multiple windows may represent the meanings, respectively. A user may tap an item in one window and then tap a comparison button to start a search. Next comparison results based on the select meaning may be retrieved and displayed.

In FIG. 8-F, an “Edit” button may be configured in the interface (not shown). The button may provide options to adjust rules for selecting comparators and comparison factors. For example, a user may tap “Edit” button to open an edit window and then enter an editing mode. In the editing mode, the user may change parameters and conditions which define a comparator selecting process. For example, a user may change the maximum distance allowed between an object and a comparator. The user may also add for an object requirement for delivery service or requirement for online ordering service. The user may also specify which comparison factors may show up first.

As in some cases a user may want to see detailed information after viewing concise summaries, an interactive button, which may have a label such as “Detail”, may be configured on surface 64 of FIG. 8-F (not shown). The button may be designed to provide a list of links of review reports or articles. So a user may start a search for comparison info on an object, take a look at concise summaries provided as comparison results, and then tap the “Detail” button to retrieve links to review reports which are related to the concise summaries. To accommodate such a function, more information may be collected and added to comparison attributes of entities or objects. Thus, comparison attributes may have not only comparison values which are in a concise form, but also links to sources from which comparison values are obtained or derived. Through the links, a user may access articles, news, posts, or reports on an object. Information from these links may differ from conventional search results, because the information may be related to a comparator. For example, a comparison-related article may focus on comparators of an object, not the object.

Lastly, an interactive arrow button may be configured on the right hand side of “Pricing” button of FIGS. 8-C to 8-F (not shown). The arrow button may be placed next to “Pricing” button and have an arrow symbol on it that points to the right-hand direction. If the arrow button is tapped, an icon of a new comparison factor may appear. A user may tap the new icon to see comparison values under the new comparison factor for the three pizza places. The arrow button brings options for more comparison factors and consequently more comparison results. Again, it is assumed that comparison attributes contain more comparison factors than those shown in a comparison window. The arrow icon enables a user to select every comparison factor available at comparison attributes, which provides flexibility for comparison window design and convenience for users.

Therefore the scope of the invention should be determined by the appended claims and their legal equivalents, rather than by the examples given.

1. A computer implemented method performed for presenting search information and comparison information at an electronic device, the electronic device having an interface and stored executable instructions, comprising:
presenting simultaneously in the interface a query input space for a user to enter a query and an interactive search element;
making an interactive comparison element visible and displayed with the query input space in response to the user enters the query in the query input space at least partially, wherein the search element provides a search option for obtaining a search result which is based on the query, the comparison element provides a comparison option for obtaining a comparison result which is based on an object obtained from the query and one or more comparators comparable to the object, and the search element and the comparison element are shown together in the interface;
sending the query to a service facility after the user enters the query and activates the search element or activates the comparison element;
receiving from the service facility the search result after the search element is activated or receiving from the service facility the comparison result after the comparison element is activated; and
presenting in the interface the search result or comparison result after the receiving step, the comparison result comprising a plurality of concise summaries based on the object, the one or more comparators, and a comparison factor.

2. The method according to claim 1, further including presenting the one or more comparators.

3. The method according to claim 1, further including presenting an additional element for an image search or a video search in the interface.

4. The method according to claim 1 wherein the comparison factor includes a pricing factor.

5. The method according to claim 1 wherein the plurality of concise summaries have a same presentation format.

6. The method according to claim 1 wherein the plurality of concise summaries each contain no more than a few items besides expression of summary identity, the items including a number, a word, a letter, a character, a sign, a symbol, an image, or a video clip.

7. The method according to claim 1 wherein the comparison factor includes a rating factor and/or a review quantity factor.

8. A computer implemented method performed for presenting comparison information at an electronic device, the electronic device having an interface and stored executable instructions, comprising:
presenting a query input space in the interface;
in response to that a query is entered at least partially in the query input space by a user, making an interactive comparison element visible and displayed with the query input space;
transmitting the query to a service facility after the comparison element is activated by the user;
obtaining a comparison result from the service facility, the comparison result comprising information about an object obtained from the query and one or more comparators which are comparable to the object; and
presenting in the interface the comparison result, the comparison result further comprising a plurality of concise summaries based on the object, the one or more comparators, and one or more comparison factors.

9. The method according to claim 8, further including presenting simultaneously in the interface a search result based on the query and/or the comparison result.

10. The method according to claim 8, further including presenting an interactive search element for a search request and making the interactive comparison element visible after the query is entered at least partially in the query input space.

11. The method according to claim 8 wherein the plurality of concise summaries each contain no more than a few items besides expression of summary identity, the items including a number, a word, a letter, a character, a sign, a symbol, an image, or a video clip.

12. The method according to claim 8 wherein the query is received through a voice recognition mechanism.

13. The method according to claim 8 wherein one of the plurality of concise summaries contains an image or a video clip only.

14. The method according to claim 8, further including presenting one or more interactive elements for an image search and/or a video search.

15. A computer implemented method performed for presenting information at an electronic device, the electronic device having an interface and stored executable instructions, comprising:
presenting an input space in the interface for a user to enter content of a request for information;
displaying in the interface the content of the request for information in the interface after the user enters it, the content of the request for information including a word, a text, an image, a picture, or a video;
presenting an interactive element in the interface;
in response to activation of the interactive element, transmitting the request for information to a service facility;
obtaining a first result from the service facility, the first result comprising information about an object obtained from the content of the request for information and one or more comparators that are comparable to the object; and
presenting the first result in the interface, the first result further comprising a plurality of concise summaries based on the object, the one or more comparators, and one or more comparison factors.

16. The method according to claim 15, further including presenting a second result in the interface, the second result being based on a search with respect to the content of the request for information.

17. The method according to claim 15, further including presenting the one or more comparators in the interface before presenting the first result.

18. The method according to claim 15, further including presenting an interactive graphic object in the interface for a search based on the content of the request for information.

19. The method according to claim 15 wherein presenting the interactive element in the interface is performed after the content of the request for information is entered at least partially by the user.

20. The method according to claim 15 wherein the request for information is received through a voice recognition mechanism.
